(19) United States
(12) Patent Application Publication
(10) Pub. No.: US 2005/0185331 A1
(43) Pub. Date: Aug. 25, 2005

(54) Magnetic disk device, assembly method of magnetic disk device, and disassembly method of magnetic disk device

(75) Inventor: Kazuo Ito, Hamura-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/043,058

(22) Filed: Jan. 27, 2005

(30) Foreign Application Priority Data
Feb. 25, 2004 (JP) 2004-050269

(51) Int. Cl. G11B 17/02

(52) U.S. Cl. 360/99.12

(57) ABSTRACT

A magnetic disk device includes a hub and a clamper. The hub has a hole portion including a first fitting portion, and a mounting portion mounting a magnetic disk. Besides, the damper has: an inserting portion including, an opening, slits heading toward an outer peripheral from the opening, and a second fitting portion; and a pressing portion pressing the magnetic disk. The magnetic disk is mounted on the mounting portion of the hub, the inserting portion of the damper is inserted into the hole portion of the hub, and thereby, the first and the second fitting portions are fitted together to fix the magnetic disk to the hub. At this time, the inserting portion has slits, and thereby, the elastic deformation becomes easy, and enabling a detachment and attachment of the clamper from/to the hub. Moreover, any dedicated fixture or screw is not necessary to attach the clamper.

### ROSS-REFERENCE TO THE INVENTION

This application is based upon and claims the benefit of priority from the prior Japanese Patent Application No. 2004-050269, filed on Feb. 25, 2004; the entire contents of which are incorporated herein by reference.

### BACKGROUND OF THE INVENTION

1. Field of the Invention

The present invention relates to a magnetic disk device holding a magnetic disk by using a clamper, an assembly method of a magnetic disk device, and a disassembly method of a magnetic disk device.

2. Description of the Related Art

A magnetic disk device performs a record and playback of information using a magnetic disk as a recording medium. The magnetic disk is held and rotated on a hub of a disk motor, and thereby, the record and playback of the information to/from the magnetic disk is performed.

Here, there is disclosed an art in which a clamp portion projecting downward from a disk clamper is inserted into a recessed portion of an upper surface of the hub and caulked, and thereby, the magnetic disk is fixed to the hub (refer to Japanese Patent Laid-open Application No. Hei 8-124263 (Document 1)). It is not necessary to use a screw for fixing the magnetic disk, and therefore, it becomes possible to make the magnetic disk device thinner as corresponding to a head portion of the screw.

Besides, there is disclosed an art in which a clamp disk having a web-shaped portion and a slit portion is used, the web-shaped portion is expanded in an outer peripheral direction by using a fixture, and attached to a lead portion of a spindle hub to hold a magnetic disk to the spindle hub (refer to Japanese Patent Laid-open Application No. 2003-6970 (Document 2)). Attachment and detachment of the clamp disk become possible.

### SUMMARY OF THE INVENTION

In the art described in the Document 1, the clamp portion is caulked to fix the disk clamper, and therefore the detachment/attachment of the disk clamper is difficult. Besides, in the art described in the Document 2, it is possible to detach the clamp disk, but some dedicated fixture is necessary to attach the clamp disk.

The object of the present invention is to provide a magnetic disk device, an assembly method of the magnetic disk device, and a disassembly method of the magnetic disk device, in which attachment and detachment of the magnetic disk to/from the hub are possible, and there is no need to use a screw or a dedicated fixture to attach the magnetic disk to the hub.

The magnetic disk device according to the present invention includes: a magnetic disk having a first opening; a hub disposed in accordance with the first opening, having a hole portion including a first fitting portion and a mounting portion mounting the magnetic disk; and a clamper having: an inserting portion inserted into the hole portion, and the inserting portion including, a second opening, slits heading toward an outer peripheral direction from the second opening, and a second fitting portion disposed in the vicinity of the opening and corresponding to the first fitting portion; and a pressing portion pressing the magnetic disk.

The hub has the hole portion including the first fitting portion and the mounting portion mounting the magnetic disk. The damper has: the inserting portion including, the opening, slits heading toward the outer peripheral direction from the opening, and the second fitting portion disposed in the vicinity of the opening and corresponding to the first fitting portion; and a pressing portion pressing the magnetic disk.

The magnetic disk is mounted on the mounting portion of the hub, and the inserting portion of the damper is inserted into the hole portion of the hub, and thereby, the first and second fitting portions are fitted together to fix the magnetic disk to the hub.

At this time, the inserting portion has slits, and therefore, the elastic deformation of the inserting portion becomes easy when it is inserted into the hole portion of the hub. As a result, the detachment/attachment of the clamper from/to the hub becomes possible. Besides, the attachment of the damper to the hub can be performed by inserting the inserting portion of the clamper to the hole portion of the hub, and therefore, there is no need to use a dedicated fixture to attach the clamper. Further, a screw is not necessary to attach the damper to the hub, and therefore, it becomes possible to make the thickness of the magnetic disk device thinner by eliminating the height corresponding to the head of the screw.

(1) Here, the magnetic disk device may further include: a shaft; and a rotating mechanism disposed between the shaft and the hub, and making the hub rotatable relative to the shaft, and wherein the hole portion is disposed at an outer periphery of the rotating mechanism.

The shaft is rotatable relative to the hub, and moreover to the hole portion by means of the rotating mechanism. Therefore, when the magnetic disk is rotating, the shaft can be fixed to attach the hub to a base of the magnetic disk device by using the shaft.

Further, the hub can be fixed stably from both sides, above and below of the shaft. Incidentally, as the rotating mechanism, lubricating means such as a ball bearing, a liquid lubrication, and so on, can be used.

(2) The hole portion of the hub may have a first introducing portion whose inside diameter becomes smaller from an entrance toward a back, and the inserting portion of the damper may have a second introducing portion whose outside diameter becomes larger from a tip portion toward a center.

When the inserting portion of the damper is inserted and attached to the hole portion of the hub, these first and second introducing portions are engaged together, and thereby, the insertion can be performed smoothly. Besides, the detachment of the clamper from the hub can be performed smoothly.

### BRIEF DESCRIPTION OF THE DRAWINGS

FIG. 1 is a perspective view showing a magnetic disk device according to an embodiment of the present invention.

FIG. 2 is a sectional view showing an enlarged cross section of the magnetic disk device at around the center.

FIG. 3A is a front view showing a detail of a clamper.

FIG. 3B is a sectional view showing the detail of the clamper.

FIG. 3C is a perspective view showing the detail of the clamper.

FIG. 4A is a sectional view showing a state before the damper is attached to a hub.

FIG. 4B is a sectional view showing a state after the damper is attached to the hub.

FIG. 5A is a sectional view showing a state of a magnetic disk device divided into above and below parts at around the center for the explanation of a detachment of the damper from the hub using a damper detaching fixture.

FIG. 5B is a sectional view showing a state of the clamper detaching fixture divided into left and right parts in the vicinity of the recessed portion for the explanation of the detachment of the damper from the hub using the damper detaching fixture.

FIG. 6A is a sectional view showing a state of the magnetic disk device divided into above and below parts at around the center for the explanation of the detachment of the damper from the hub using the damper detaching fixture.

FIG. 6B is a sectional view showing a state of the damper detaching fixture divided into left and right parts in the vicinity of the recessed portion for the explanation of the detachment of the damper from the hub using the damper detaching fixture.

### DESCRIPTION OF THE EMBODIMENTS

Hereinafter, an embodiment of the present invention is described in detail with reference to the drawings.

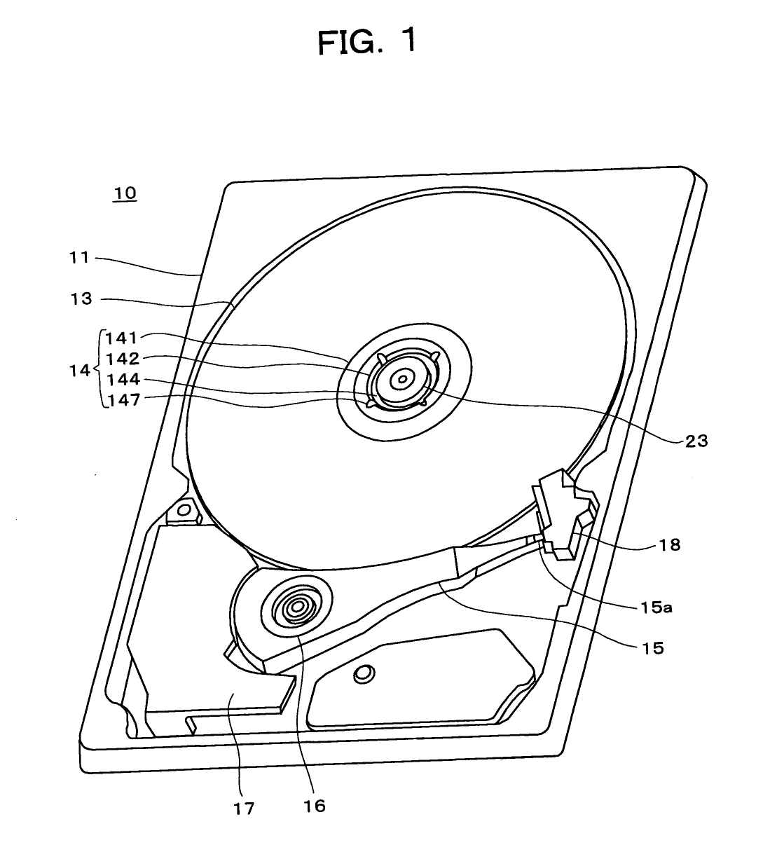

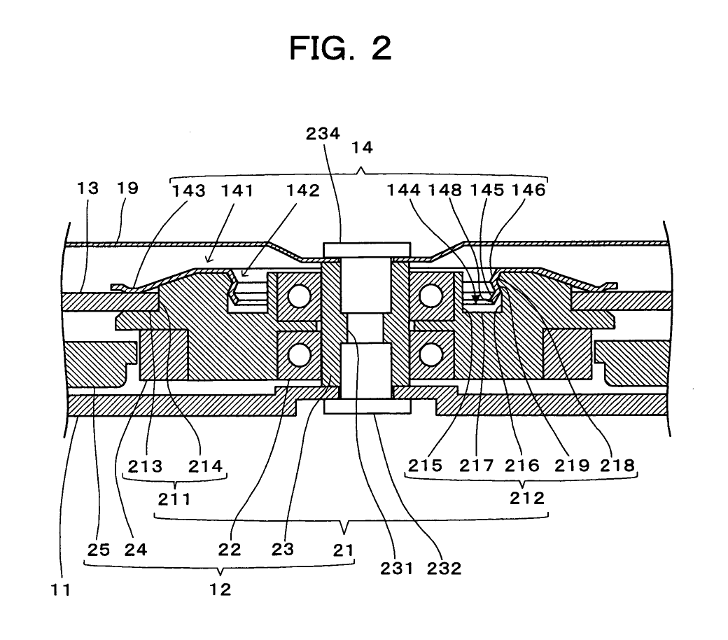

FIG. 1 is a perspective view showing a magnetic disk device 10 according to an embodiment of the present invention. FIG. 2 is a sectional view showing an enlarged cross section of the magnetic disk device 10 at around the center. Incidentally, FIG. 1 represents a state in which a later-described cover 19 is removed so as to show an inside of the magnetic disk device 10.

The magnetic disk device 10 has a base 11, a spindle motor 12, a magnetic disk 13, a clamper 14, a head sub assembly 15, a bearing unit 16, a voice coil motor 17, a head amp circuit 18, and the cover 19.

On the base 11, the spindle motor 12, the head sub assembly 15, the bearing unit 16, the voice coil motor 17, and the head amp circuit 18 are provided, and they are shielded by the cover 19 from outside. Besides, the magnetic disk 13 is attached to the spindle motor 12, and it is fixed by the damper 14. The head sub assembly 15 has a magnetic head 15a to perform a record and playback of data to the magnetic disk 13, and it is rotatably supported by the bearing unit 16 and driven by the voice coil motor 17.

As shown in FIG. 2, the spindle motor 12 has a hub 21, a bearing 22, a motor shaft 23, magnets 24, and a coil 25.

The hub 21 is for mounting and fixing the magnetic disk 13, and has a disk mounting portion 211 and a clamp insertion hole 212.

On the disk mounting portion 211, the magnetic disk 13 is to be mounted, and it has a ring-shaped upper surface portion 213 corresponding to a lower surface of the magnetic disk 13 and a side portion 214 having a curved surface curved in an arc shape in accordance with a circular opening of the magnetic disk 13.

The clamp insertion hole 212 is a ring-shaped hole provided in the vicinity of a rotation center of the spindle motor 12, in which a later-described projecting portion 142 of the damper 14 is inserted and fitted. The clamp insertion hole 212 has an inner peripheral side surface 215, an outer peripheral side surface 216, a bottom surface 217, a damper introducing portion 218, and a fitting portion 219.

The inner peripheral side surface 215 and the outer peripheral side surface 216 are curved surfaces curved in an arc shape, and they are positioned at an inner peripheral side and an outer peripheral side of the rotation center of the spindle motor 12, respectively.

The damper introducing portion 218 functions as a guide so that the projecting portion 142 is inserted into the clamp insertion hole 212 smoothly. For this purpose, the damper introducing portion 218 has a so-called tapered shape in which an upper inside diameter is larger than a lower inside diameter.

The fitting portion 219 is disposed on the outer peripheral side surface 216, and it is an approximately ring-shaped projection to fit with the projecting portion 142 of the damper 14.

The bearing 22 is a member to connect the hub 21 with the motor shaft 23 rotatably. Ball bearings are used to reduce a friction between the hub 21 and the motor shaft 23. Instead of the above, other lubricating means such as a liquid lubrication (what is called a liquid bearing) can be used.

The motor shaft 23 is a member to fix the hub 21 to the base 11, and it is fixed to the base 11 by a screw 232 screwed on a lower side of a screw hole 231. Besides, the cover 19 is held by a screw 234 screwed on an upper side of the screw hole 231. Namely, the spindle motor 12 is a both sides supporting type which can fix the hub 21 from both sides, above and below of the motor shaft 23.

The magnets 24 are plurally provided in an arc shape along an outer periphery of the hub 21, and rotate the hub 21 and furthermore the magnetic disk 13 by an attraction and repulsion with the coil 25.

The coil 25 has an inner peripheral facing with the outer periphery of the magnets 24, generates a magnetic field by a current, and rotates the hub 21 by an attraction and repulsion with the magnets 24.

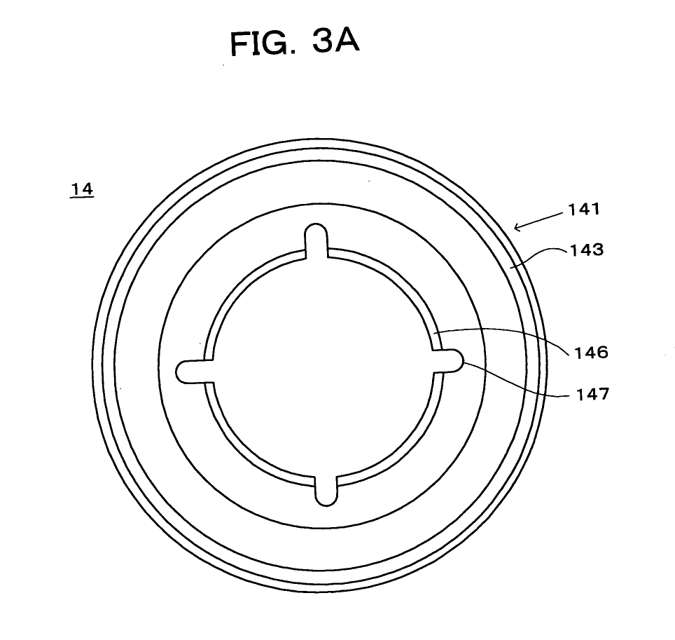

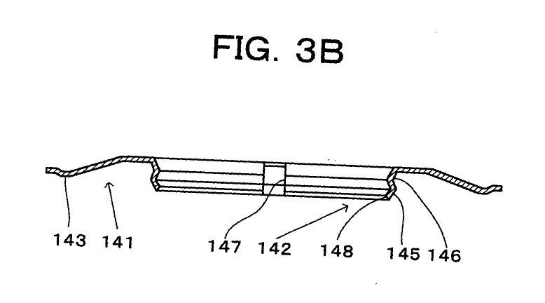

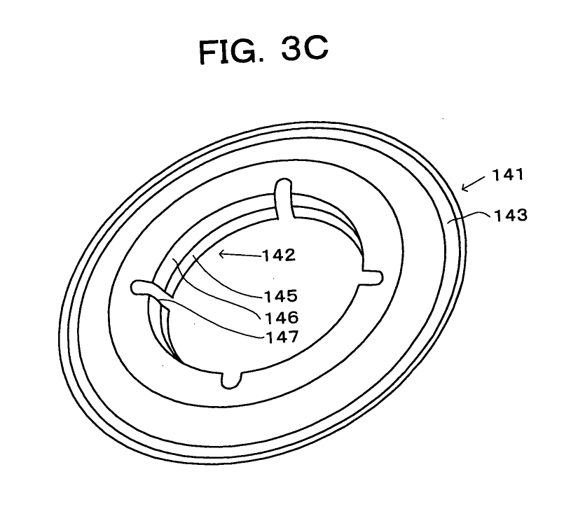

FIG. 3A to FIG. 3C are the front view, the sectional view, and the perspective view respectively showing the details of clamper 14.

The damper 14 has an approximately disc-shaped disk pressing portion 141 and the approximately cylindrical shaped projecting portion 142, and it presses an uppermost surface of the magnetic disk 13 to fix to the hub 21.

The disk pressing portion 141 is in contact with the upper surface of the magnetic disk 13 with a disk contacting portion 143, to press and fix the magnetic disk 13 to an upper surface portion 213 of the disk mounting portion 211.

The projecting portion 142 is a member to be inserted and fixed to the clamp insertion hole 212, projecting downward from the damper 14, and having an opening 144, an introducing portion 145, a fitting portion 146, slits 147, and an end portion 148.

The opening 144 is provided to make the projecting portion 142 thinner so as to perform an elastic deformation thereof easily.

The introducing portion 145 functions as a guide for the projecting portion 142 to be inserted into the clamp insertion hole 212 smoothly. For this purpose, the introducing portion 145 has so-called a tapered shape in which an upper outside diameter is larger than an lower outer diameter.

The fitting portion 146 is a recession formed on an outer periphery of the projecting portion 142 to fit with the fitting portion 219 of the clamp insertion hole 212, and having approximately a ring shape. Namely, a step provided at the clamp insertion hole 212 (fitting portion 219) and a step at the outer periphery of the projecting portion 142 (fitting portion 146) are corresponding, and thereby, the damper 14 is fixed to the hub 21, and it becomes possible to press and fix the magnetic disk 13. Incidentally, in the present embodiment, the fitting portion 146 is concave and the fitting portion 219 is convex, but on the contrary, it is also possible that the fitting portion 146 is convex and the fitting portion 219 is concave.

The slits 147 are formed in a radial pattern from the opening 144, and divide the projecting portion 142, and thereby, an approximately individual elastic deformation of the divided respective projecting portions 142 becomes possible. As a result, the insertion of the projecting portion 142 to the clamp insertion hole 212 becomes possible within the range of the elastic deformation of the projecting portion 142. Namely, without these slits 147, when the projecting portion 142 is inserted into the clamp insertion hole 212, the entire projecting portion 142 is compressed toward the center thereof, and it becomes easy to be plastic deformed. As described later, the slits 147 are also used as an inserting portion to insert a later-described damper detaching fixture 30 when the damper 14 is detached from the hub 21. Incidentally, in the present embodiment, the four slits 147 are provided along the opening 144 and split the projecting portion 142 into four parts, but the number of the slits is not limited to four, and it is possible to set the number to be, for example, from two to three, or five and more.

As described later, the end portion 148 engages with the clamper detaching fixture 30, and used for detaching the damper 14 from the hub 21.

(Attachment of Clamper)

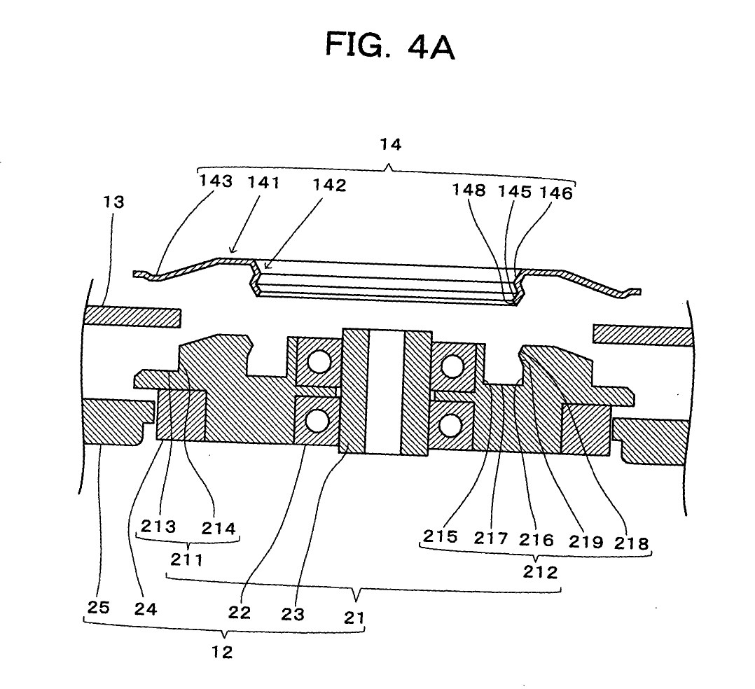

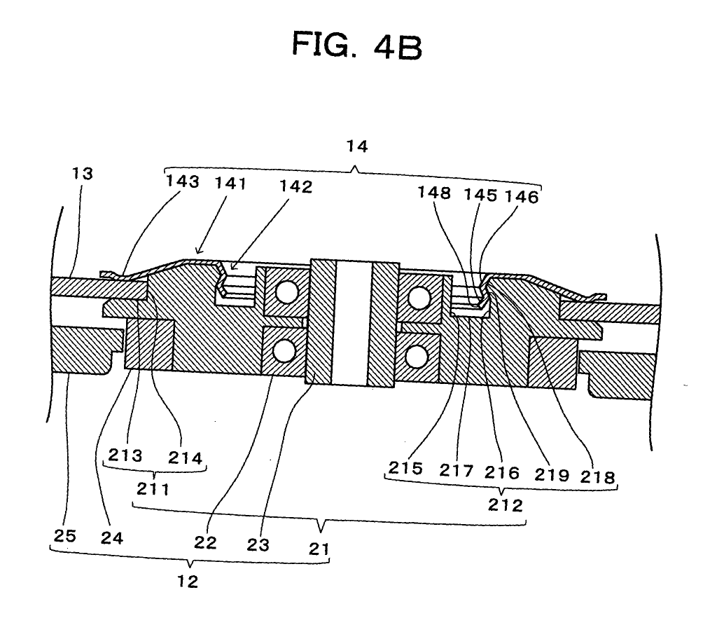

FIG. 4A and FIG. 4B are sectional views respectively showing states before and after the damper 14 is attached to the hub 21. Incidentally, in FIG. 4A and FIG. 4B, they are shown without the base 11 for easy-to-understand.

The magnetic disk 13 is mounted on the disk mounting portion 211 of the hub 21, and the projecting portion 142 of the damper 14 is placed to face with the clamp insertion hole 212 of the hub 21. The upper portion in the vicinity of center of the damper 14 is pressed, and then, the projecting portion 142 of the damper 14 is inserted into the clamp insertion hole 212 of the hub 21. At this time, the slits 147 are provided at the projecting portion 142, and therefore, when the introducing portion 145 is in contact with the damper introducing portion 218 of the hub 21, the projecting portion 142 is elastically deformed easily. Consequently, the insertion of the projecting portion 142 to the clamp insertion hole 212 becomes easy. Besides, the respective introducing portions 145, 218 of the damper 14 and the hub 21 have the corresponding tapered shape, and therefore, the insertion of the projecting portion 142 to the clamp insertion hole 212 can be performed smoothly.

The projecting portion 142 is inserted into the clamp insertion hole 212, and thereby, the fitting portion 219 of the clamp insertion hole 212 and the fitting portion 146 of the clamper 14 are fitted together, and the clamper 14 is fixed to the hub 21. It is not required to use any special dedicated fixture, and so on, for this insertion and fitting. The operation can be performed by using a general-purpose tool or an assembly machine.

(Detachment of Clamper)

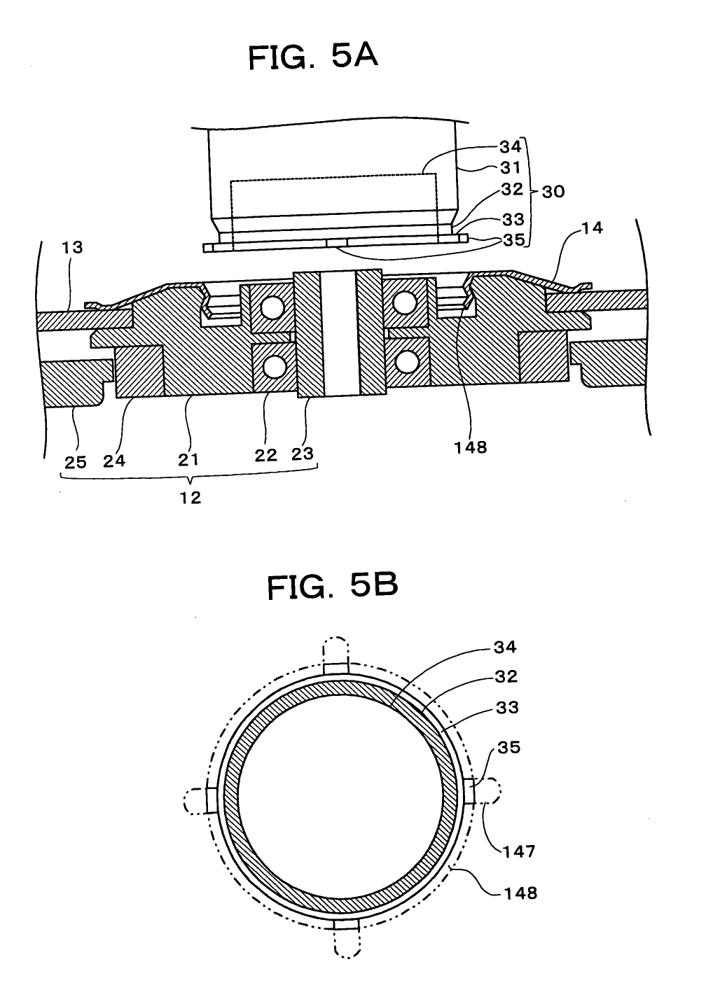

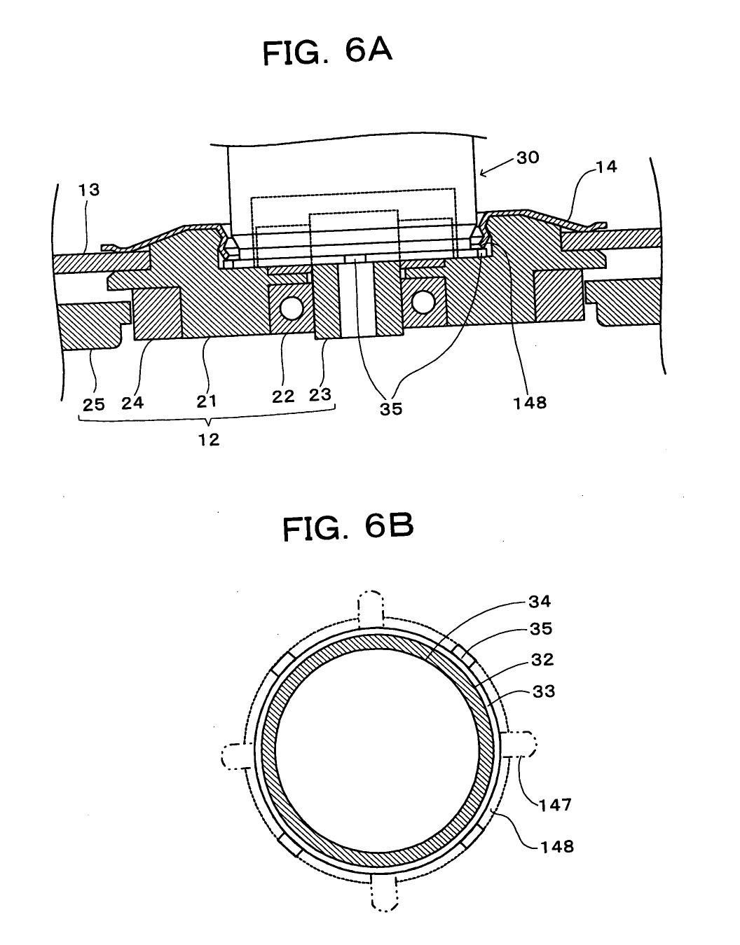

FIG. 5A, FIG. 5B, FIG. 6A, and FIG. 6B are sectional views explaining the detachment of the clamper 14 from the hub 21 by using the clamper detaching fixture 30. Incidentally, in FIG. 5A and FIG. 5B, they are shown without the base 11 for easy-to-understand.

FIG. 5A and FIG. 5B represent the states in which the clamper detaching fixture 30 is disposed in accordance with the slits 147 of the clamper 14. FIG. 5A is a sectional view showing the magnetic disk device 10 divided into above and below parts at around the center. Besides, FIG. 5B is a sectional view showing the clamper detaching fixture 30 divided into left and right parts in the vicinity of a later-described recessed portion 32, and the clamper 14 is shown in a virtual line (two-dot chain line).

FIG. 6A and FIG. 6B show the state that the clamper detaching fixture 30 is rotated for 45 degrees from the point corresponding to the slits 147 of the clamper 14. FIG. 6A is a sectional view of the magnetic disk device 10 divided into above and below parts at around the center. Besides, FIG. 6B is a sectional view of the clamper detaching fixture 30 divided into left and right parts in the vicinity of the later described recessed portion 32, and the clamper 14 is shown in a virtual line (tow-dot chain line).

As shown in FIG. 5A, FIG. 5B, FIG. 6A, and FIG. 6B, the damper detaching fixture 30 has a shaft portion 31, the recessed portion 32, hook portion 33, and a hole portion 34.

The shaft portion 31 has approximately a column shape, and used for the operation of the damper detaching fixture 30. This operation can be performed by both manual and automated machine. The recessed portion 32 functions as an escape when the hook portion 33 is inserted into the slits 147 of the damper 14. The hook portion 33 has claws 35 to hook the damper 14. These claws 35 are disposed so as to correspond to the slits 147. The hole portion 34 is provided so that the damper detaching fixture 30 does not clash against the motor shaft 23, the bearing 22, and so on.

The detachment of the clamper 14 from the hub 21 is performed as follows.

The craws 35 of the clamper detaching fixture 30 are disposed so as to correspond to the slits 147 (FIG. 5A, FIG. 5B).

The shaft portion 31 is operated to insert the craws 35 of the hook portion 33 into the slits 147. As a result, the craws 35 are disposed in a space between the lower surface of the projecting portion 142 of the damper 14 and the bottom surface 217 of the clamp insertion hole 212. The damper detaching fixture 30 is rotated for approximately 45 degrees, and the craws 35 are moved within this space, so as to face the craws 35 with the lower surface of the projecting portion 142 of the damper 14 (FIG. 6A, FIG. 6B).

Subsequently, the damper detaching fixture 30 is pulled upward, and thereby, the damper 14 is pulled upward by pressing the lower surface of the projecting portion 142 of the damper 14 with the upper surface of the craws 35. As a result, the damper 14 is detached from the hub 21.

As described above, according to the present embodiment, the detachment/attachment of the clamper 14 is possible without using a screw, and it is possible to reduce the height corresponding to the head portion of the screw. Consequently, it becomes easy to make the magnetic disk device 10 thinner.

There is not a screw at the center of the clamper 14, and therefore, the motor shaft 23 is fixed from both sides, above and below, and a so-called both sides holding becomes possible, and a stiffness of the spindle motor 12 can be improved.

Besides, the introducing portion 218 of the clamp insertion hole 212 of the hub 21 and the introducing portion 145 of the clamper 14 have corresponding forms. Especially, the shapes of these introducing portions 145, 218 have approximately rotation symmetries, and therefore, when the clamper 14 is attached to the hub 21, the respective rotation centers are corresponded. Consequently, it becomes possible to press the magnetic disk 13 with a uniform force, and thereby, a deformation of the magnetic disk 13 can be suppressed.

(Other Embodiment)

The embodiment of the present invention is not limited to the above-described embodiment, and can be enlarged and changed, and the enlarged and changed embodiments are included in the technical scope of the present invention.

For example, in the above-described embodiment, the fitting portion 146 and the fitting portion 219 are respectively disposed at the outer periphery of the projecting portion 142 and on the outer peripheral side surface 216 of the clamp insertion hole 212, but it is also possible to dispose at the inner periphery of the projecting portion 142 (the surface of the opening 144) and on the inner peripheral side surface 215 of the clamp insertion hole 212. At this time, the fitting portion 146 and the fitting portion 219 can be formed to be either convex and concave, or concave and convex, respectively.

Further, in the above-described embodiment, the number of the magnetic disk is one, but a plural number of the magnetic disks can be held by using the clamper. For example, spacers are disposed between the plural magnetic disks, and the magnetic disk of the uppermost portion is fixed by the clamper.

1. A magnetic disk device, comprising:
a magnetic disk having a first opening;
a hub disposed in accordance with the first opening, and having a hole portion including a first fitting portion and a mounting portion mounting said magnetic disk; and
a clamper having: an inserting portion inserted into the hole portion, and the inserting portion including, a second opening, slits heading toward an outer peripheral direction from the second opening, and a second fitting portion disposed in the vicinity of the opening and corresponding to the first fitting portion; and a pressing portion pressing said magnetic disk.

2. A magnetic disk device according to claim 1, further comprising:
a shaft; and
a rotating mechanism disposed between said shaft and said hub, and making said hub rotatable relative to said shaft, and
wherein the hole portion is disposed at an outer periphery of said rotating mechanism.

3. A magnetic disk device according to claim 1,
wherein the hole portion of said hub has a first introducing portion whose inside diameter becomes smaller from an entrance toward a back, and
wherein the inserting portion of said clamper has a second introducing portion whose outside diameter becomes larger from a tip portion toward a center.

4. A magnetic disk device according to claim 1,
wherein the hole portion has an inner peripheral surface and an outer peripheral surface, and
wherein the first fitting portion is disposed at either the inner peripheral surface or the outer peripheral surface.

5. A magnetic disk device according to claim 1,
wherein there is a space between the tip portion of the inserting portion and the bottom surface of the hole portion.

6. A magnetic disk device according to claim 1,
wherein the hole portion is disposed inside of the first opening.

7. A magnetic disk device according to claim 1,
wherein the inserting portion of said damper includes a plurality of slits.

8. A magnetic disk device according to claim 1,
wherein the inserting portion is constituted by a plate-shaped member.

9. An assembly method of a magnetic disk device, comprising:
preparing a hub having a hole portion disposed at an inner peripheral side, and including a first fitting portion, and a mounting portion disposed at an outer peripheral side;
mounting a magnetic disk having a first opening on the mounting portion, and disposing the hole portion inside of the first opening;
fitting the first fitting portion and a second fitting portion by inserting an inserting portion of a damper which has: the inserting portion including, a second opening, slits heading toward an outer peripheral direction from the second opening, and the second fitting portion disposed in the vicinity of the second opening; and a pressing portion, into the hole portion, and pressing the magnetic disk with the pressing portion.

10. An assembly method of the magnetic disk according to claim 9,
wherein a shaft and a rotating mechanism which is disposed between the shaft and the hub, and making the hub rotatable relative to the shaft, are connected to the hub, and
wherein the hole portion is disposed at the outer periphery of the rotating mechanism.

11. An assembly method of the magnetic disk according to claim 9,
wherein the hole portion of the hub has a first introducing portion whose inside diameter becomes smaller from an entrance toward a back, and
wherein the inserting portion of the damper has a second introducing portion whose outside diameter becomes larger from a tip portion toward a center.

12. An assembly method of the magnetic disk according to claim 9,
wherein the hole portion has an inner peripheral surface and an outer peripheral surface, and
wherein the first fitting portion is disposed on either the inner peripheral surface or the outer peripheral surface.

13. An assembly method of the magnetic disk according to claim 9,
wherein the inserting portion of the damper includes a plurality of slits.

14. An assembly method of the magnetic disk according to claim 9,
wherein the inserting portion is constituted by a plate-shaped member.

15. A disassembly method of a magnetic disk device, comprising:
preparing the magnetic disk device including: a magnetic disk having an opening; a hub having a hole portion disposed in accordance with the opening and including a first fitting portion, and a mounting portion mounting the magnetic disk; a damper having: an inserting portion inserted into the hole portion, and the inserting portion including, an opening, slits heading toward an outer peripheral direction from the opening, and a second fitting portion disposed in the vicinity of the opening and corresponding to the first fitting portion; and a pressing portion to press the magnetic disk;
inserting craws of a fixture into the slits;
moving the craws between the inserting portion and the hole portion; and
detaching the damper from the hub by applying a force to the inserting portion in an away direction from the hole portion by the craws.

16. A disassembly method of the magnetic disk device according to claim 15,
wherein a shaft and a rotating mechanism are connected to the hub, and the rotating mechanism is disposed between the shaft and the hub and making the hub rotatable relative to the shaft, and
wherein the hole portion is disposed at an outer periphery of the rotating mechanism.

17. A disassembly method of the magnetic disk device according to claim 15,
wherein the hole portion of the hub has a first introducing portion whose inside diameter becomes smaller from an entrance toward a back, and the inserting portion of the clamper has a second introducing portion whose outside diameter becomes larger from a tip portion toward a center.

18. A disassembly method of the magnetic disk device according to claim 15,
wherein the hole portion has an inner peripheral surface and an outer peripheral surface, and the first fitting portion is disposed on either the inner peripheral surface or the outer peripheral surface.

19. A disassembly method of the magnetic disk device according to claim 15,
wherein the inserting portion of the damper includes the plurality of slits.

20. A disassembly method of the magnetic disk device according to claim 15,
wherein the inserting portion is constituted by a plate-shaped member.
